(19) United States
(12) Patent Application Publication
(10) Pub. No.: US 2008/0290149 A1
(43) Pub. Date: Nov. 27, 2008

(54) CARTONS AND METHODS OF ERECTING CARTONS

(75) Inventor: Michael D. Sweet, Penacook, NH (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Graphic Packaging International, Inc., Marietta, GA (US)

(21) Appl. No.: 12/126,352

(22) Filed: May 23, 2008

Related U.S. Application Data
(60) Provisional application No. 60/931,669, filed on May 24, 2007.

(51) Int. Cl. B65D 5/00; B31B 49/02

(52) U.S. Cl. 229/140; 493/137

(57) ABSTRACT

A carton for containing a plurality of articles. The carton has a plurality of panels end at least partially around an interior of the carton. The plurality of panels at least a first side panel and a second side panel. At least one end flap is connected to the first side panel. The end flap is for folding relative to the first el to at least partially close an end of the carton. At least one locking flap is connected to the at least one end flap. A locking aperture is in the second side r receiving at least a portion of the locking flap when the end flap at least forms the closed end of the carton.

### CROSS-REFERENCE TO RELATED APPLICATIONS

This application claims the benefit of U.S. Provisional Application No. 60/931,669, filed on May 24, 2007, the entire contents of which are hereby incorporated by reference as if presented herein in their entirety.

### BACKGROUND OF THE DISCLOSURE

The present disclosure generally relates to cartons for holding containers or other types of articles. More specifically, the present disclosure relates to cartons having various closure features.

### SUMMARY OF THE DISCLOSURE

In general, one aspect of the disclosure is directed to a carton for containing a plurality of articles. The carton comprises a plurality of panels that extend at least partially around an interior of the carton. The plurality of panels comprises at least a first side panel and a second side panel. At least one end flap foldably connected to the first side panel. The end flap is for folding relative to the first side panel to at least partially close an end of the carton. At least one locking flap is foldably connected to the at least one end flap. A locking aperture in the second side panel for receiving at least a portion of the locking flap when the end flap at least partially forms the closed end of the carton.

In another aspect, the disclosure is generally directed to a blank for forming a carton. The blank comprises a plurality of panels comprising at least a first side panel and a second side panel. At least one end flap is foldably connected to the first side panel for at least partially closing an end of the carton erected from the blank. Closure features comprise a locking flap foldably connected to the at least one end flap and a locking aperture in the second side panel for receiving at least a portion of the locking flap when the end flap at least partially closes the end of the carton erected from the blank.

In another aspect, the disclosure is generally directed to a method of assembling a carton. The method comprises providing a carton comprising a plurality of panels comprising at least a first side panel and a second side panel, at least one end flap foldably connected to the first side panel, at least one locking flap foldably connected to the at least one end flap, and a locking aperture in the second side panel. The method further comprises folding the at least one end flap to at least partially close an end the carton, and securing the at least one end flap in a position that at least partially closes the end of the carton. The securing comprises folding the at least one locking flap and inserting at least a portion of the locking flap into the locking aperture.

In another aspect, the disclosure is generally directed to a carton for containing a plurality of articles. The carton comprises a plurality of panels that extend at least partially around an interior of the carton. The plurality of panels comprises a first side panel, a second side panel foldably connected to the first side panel, a third side panel foldably connected to the first side panel, and a fourth side panel foldably connected to at least one of the second and third side panels. A first end flap is foldably connected to the first side panel. The first end flap is for folding relative to the first side panel to at least partially close a first end of the carton. A second end flap is foldably connected to the first side panel. The second end flap is for folding relative to the first side panel to at least partially close a second end of the carton. At least one first locking flap is foldably connected to the first end flap. The at least one first locking flap comprises a first portion foldably connected to the first end flap and a second portion foldably connected to the first portion of the first locking flap and at least one of the second side panel and the third side panel. At least one second locking flap is foldably connected to the second end flap. The at least one second locking flap comprises a first portion foldably connected to the second end flap and a second portion foldably connected to the first portion of the second locking flap and at least one of the second side panel and third side panel. A first locking aperture is in the at least one of the second side panel and third side panel connected to the first locking flap. The first locking aperture is for receiving at least a portion of the first locking flap when the first end flap at least partially closes the first end of the carton. A second locking aperture is in the at least one of the second side panel and third side panel connected to the second locking flap. The second locking aperture is for receiving at least a portion of the second locking flap when the second end flap at least partially closes the second end of the carton.

Other aspects, features, and details of the present disclosure can be more completely understood by reference to the following detailed description of exemplary embodiments taken in conjunction with the drawings and from the appended claims.

Those skilled in the art will appreciate the above stated advantages and other advantages and benefits of various additional embodiments reading the following detailed description of the embodiments with reference to the below-listed drawing figures. Further, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an exterior side of a blank used to form a carton according to one embodiment of the disclosure.

FIG. 2A is a view showing the blank partially assembled into the carton.

FIG. 2B is a view showing the blank further partially assembled into the carton.

FIG. 2C is a view showing the blank further partially assembled into the carton.

FIG. 2D is a view showing the blank further partially assembled into the carton.

FIG. 2E is a detail view showing an end of the assembled carton.

FIGS. 3-5 are various perspective views of the carton.

FIG. 6 is a side elevation view of the carton.

Corresponding parts are designated by corresponding reference numbers throughout the drawings.

### DETAILED DESCRIPTION OF THE EXEMPLARY EMBODIMENTS

The present disclosure generally relates to cartons, packages, constructs, sleeves, or the like, that can be for containing, holding, and displaying articles such as food containers or beverage containers. The articles can be used for packaging food or beverage products, for example. The articles can be made from materials suitable in composition for packaging the particular food or beverage item, and the materials include, but are not limited to, plastics such as PET, LDPE, LLDPE, HDPE, PP, PS, PVC, EVOH, and Nylon; and the like; aluminum and/or other metals; glass; or any combination thereof; or any other suitable material.

Cartons or packages according to the present disclosure can accommodate containers of numerous different shapes. In this specification, the terms “lower,” “bottom,” “upper” and “top” can be used to indicate orientations determined in relation to fully erected cartons.

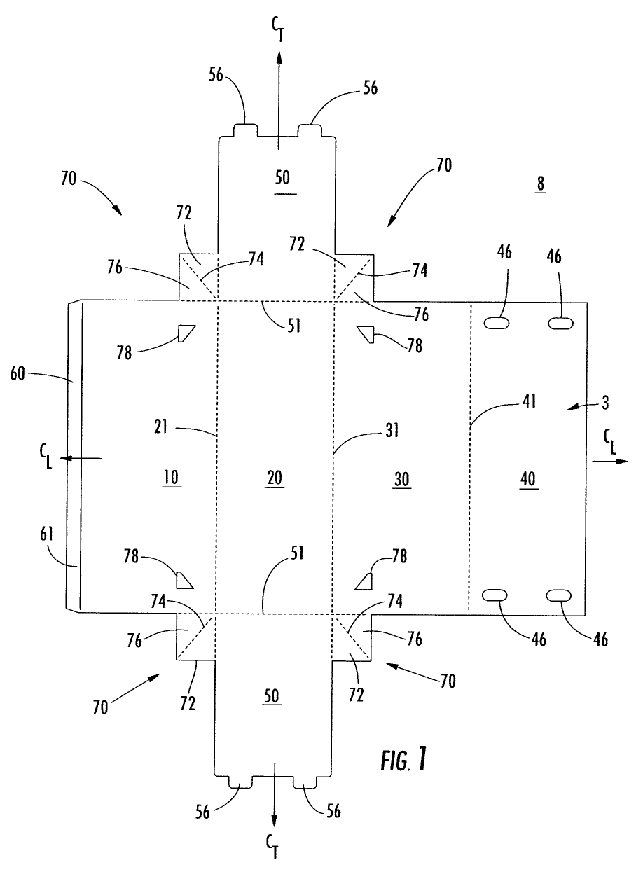

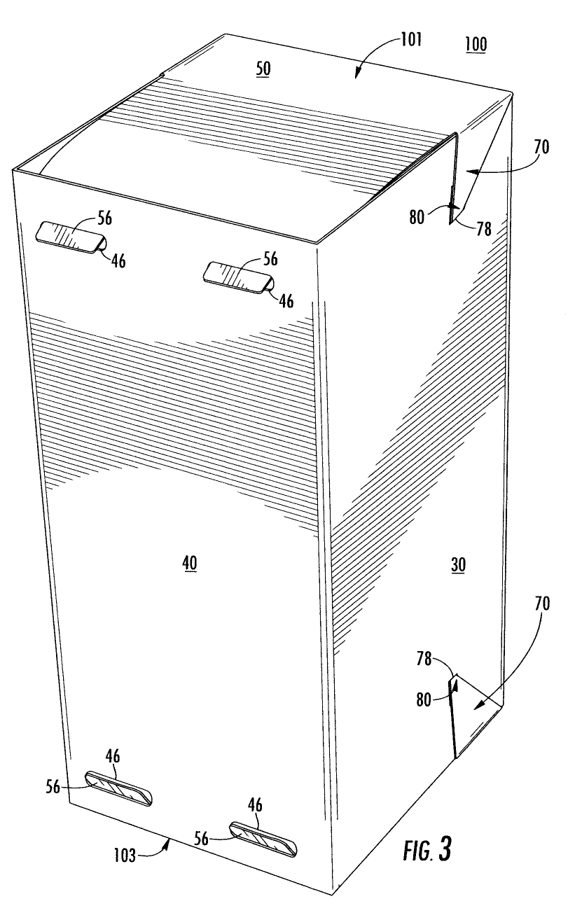

FIG. 1 is a plan view of a first, exterior or print side 3 of a blank 8 used to form a carton 100 (illustrated in FIG. 3) according to a first embodiment of the disclosure. As shown in FIG. 1, the carton blank 8 may be wholly or partially symmetric about a longitudinal centerline CL, and partially symmetric about a transverse or lateral centerline CT. Therefore, certain elements in the drawing figures share common reference numerals in order to reflect the whole and/or partial longitudinal and transverse symmetries. In this specification, the terms “side” and “end” are used merely for ease of reference and do not imply relative sizes or orientations of the panels.

Referring to FIG. 1, the carton blank 8 comprises a first side panel 20 foldably connected to a second side panel 10 at a transverse fold line 21, a third side panel 30 foldably connected to the first side panel 20 at a transverse fold line 31, a fourth side panel 40 foldably connected to the third side panel 30 at a transverse fold line 41, and end flaps 50 foldably connected to each end of the first side panel 20 at longitudinal fold lines 51. An adhesive panel 60 may be foldably connected to the second side panel 10 at a transverse fold line 61. Alternatively, an adhesive panel (not illustrated) may be connected to the fourth side panel 40 at the opposite end of the blank 8. In alternative embodiments, the fourth side panel 40 could be foldably connected to the second side panel 10 or the side panels could be otherwise arranged. The end flaps 50 close respective ends 101, 103 (FIG. 3) of the carton.

According to one exemplary aspect of the present disclosure, closure features, in the form of locking flaps 70, are located at each corner of the first side panel 20. Each locking flap 70 comprises a first portion 72 foldably connected to an end flap 50, and a second portion 76 foldably connected to the first portion 72 at an oblique fold line 74. In the illustrated embodiment each first portion 72 is generally triangular-shaped and is respectively foldably connected to each end flap 50 at a portion of one of the corresponding transverse fold lines 21, 31. Each second portion 76 is generally triangular-shaped and is respectively foldably connected to either the second side panel 10 or third side panel 30 at a portion of one of the longitudinal fold lines 51. The locking flaps 70 could be otherwise shaped, arranged, and/or positioned without departing from the disclosure.

The closure features further include locking apertures 78 (e.g., cut outs) in (e.g., extending all the way through) the second and third side panels 10, 30 that are disposed to receive respective portions of the locking flaps 70 when closing the ends of the carton 100 (illustrated in FIG. 3). In the illustrated embodiment, the locking apertures 78 (e.g., slots) are generally triangular-shaped, but the locking apertures may be otherwise shaped, arranged, and/or located.

In the illustrated embodiment, the closure features include two closure projections 56 at a marginal portion of each end flap 50. Each end flap 50 could include more or less than two closure projection 56. The closure projections 56 could be omitted from one or both end flaps 50 and the closure projections could be otherwise shaped, arranged, and positioned.

In the illustrated embodiment, the closure features include projection apertures 46 (e.g., cutouts) in (e.g., extending all the way through) the fourth side panel 40. The projection apertures 46 are respectively sized and located for receiving one of the closure projections 56 when the end flaps 50 are positioned to close a respective end 101, 103 of the carton 100. For example, the projection apertures 46 (e.g., slots) may be obround or any other suitable shape.

The fold lines 21, 31, 41, 51, 61, 74 formed in the blank 8 may be, for example, score lines, cut-space lines, cut-crease lines, overlapping and/or sequential combinations thereof, or other lines of disruption that facilitate folding, bending and/or erection of the blank 8. In the illustrated exemplary embodiment, the fold lines 21, 31, 41, 51, 61, 74 are crease lines.

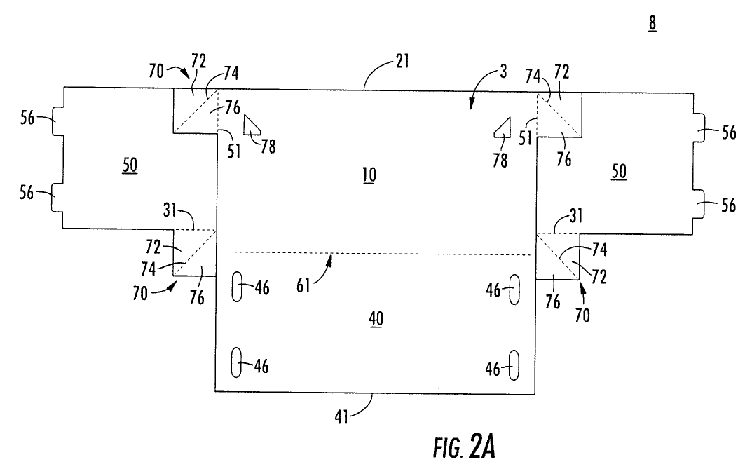

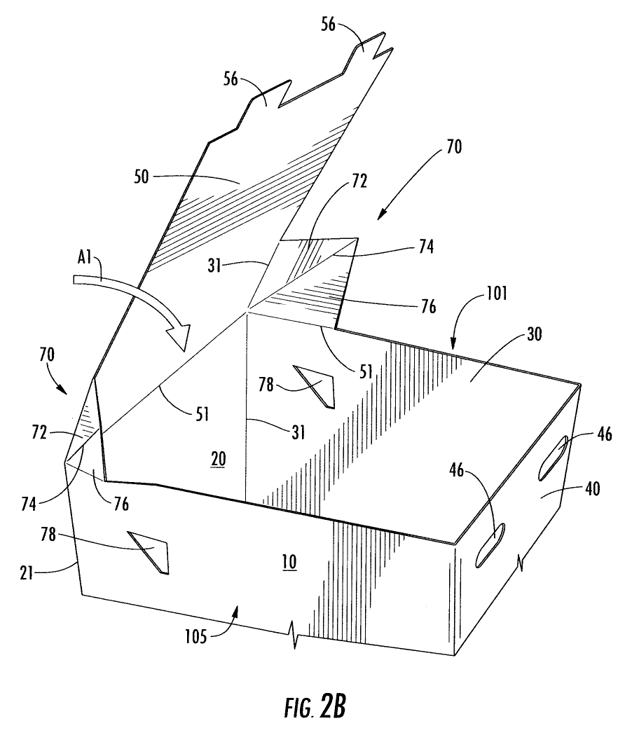

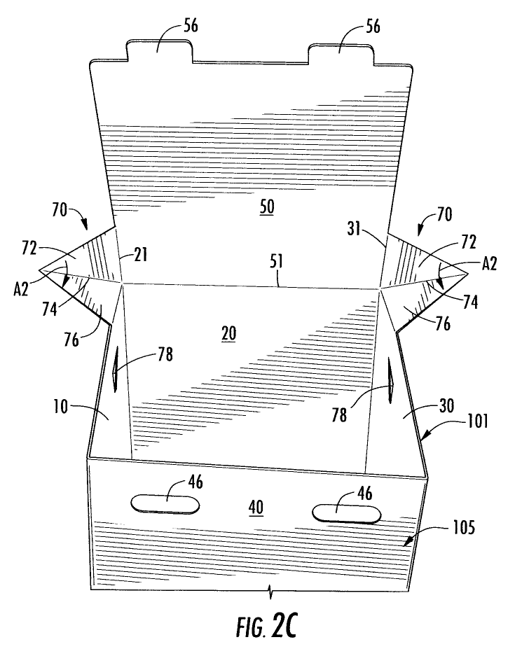

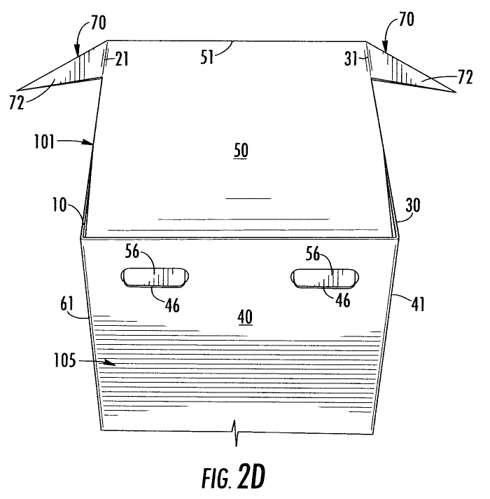

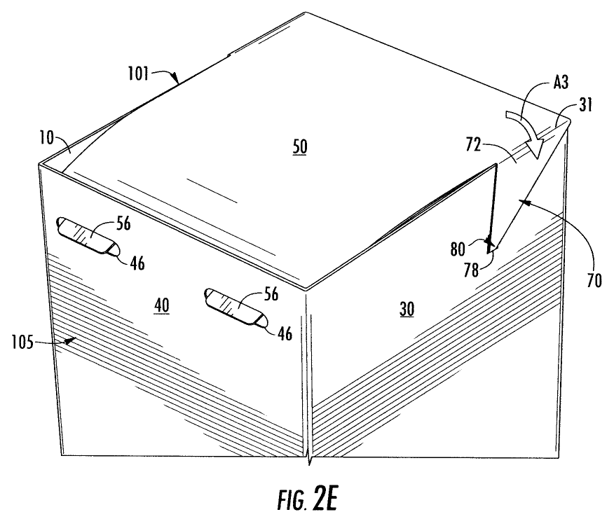

An exemplary method of erection of the carton 100 from the blank 8 is discussed below with reference to FIGS. 1 through 2E. Referring to FIGS. 1 and 2A, the carton blank 8 may be provided with glue or other adhesive on the print or exterior side of the adhesive panel 60. The blank 8 is folded flat about the transverse fold lines 21, 41 so that the exterior side of the adhesive panel 60 is brought into contact with the underside of the fourth side panel 40 and adhered thereto. The blank 8 is further assembled to form a generally open-ended sleeve 105 (partially illustrated in FIG. 2B) formed by the positioning of the side panels 10, 20, 30, 40 at transverse fold lines 21, 31, 41, 61.

FIGS. 2B-2E illustrate closure of one end 101 of the partially assembled carton (e.g., open-ended sleeve 105). The opposite end 103 may be closed in a similar manner as described for end 101, or the opposite end 103 may have an alternative closing arrangement. Referring to FIGS. 2B and 2C, the end 101 of the open-ended sleeve 105 is closed by pivoting the end flap 50 about the fold line 51 in the direction of arrow A1 (FIG. 2B). As the end flap 50 is pivoted downward, each first portion 72 pivots outward at fold line 21, 31 and each second portion 76 of the locking flap 70 pivots outward at fold line 51 to the position generally shown in FIGS. 2B and 2C. As the end flap 50 is further downwardly folded from the position of FIG. 2C to the position of FIG. 2D, the first portion 72 of each locking flap 70 is folded about oblique fold line 74, in the direction of arrows A2, to be in face-to-face relation with the second portion 74 of the locking flap. As illustrated in FIG. 2D, the overlapped first and second portions 72, 74 form each locking flap 70 which is generally triangular-shaped (or any other suitable shape) and extends outward from respective sides of the end flap 50. The first and second portions 72, 74 may be adhered together by adhesive or the first and second portions can be free from adhesive or can be secured by other suitable means.

Referring to FIG. 2D, the end flap 50 can be initially secured in a position closing the end 101 of the carton 100 by engaging (e.g., inserting) the closure projections 56 projecting from the end flap 50 with (e.g., into) corresponding closure apertures 46 in the fourth side panel 40.

Referring to FIG. 2E, the end flap 50 can be further secured in the closed position by pivoting the locking flaps 70 in the direction of arrow A3 so that a portion (e.g., tip 80) of each of the locking flaps can be pressed into an adjacent locking aperture 78. A greater or lesser extent of locking flaps 70 may be received in the locking apertures 78 without departing from the disclosure.

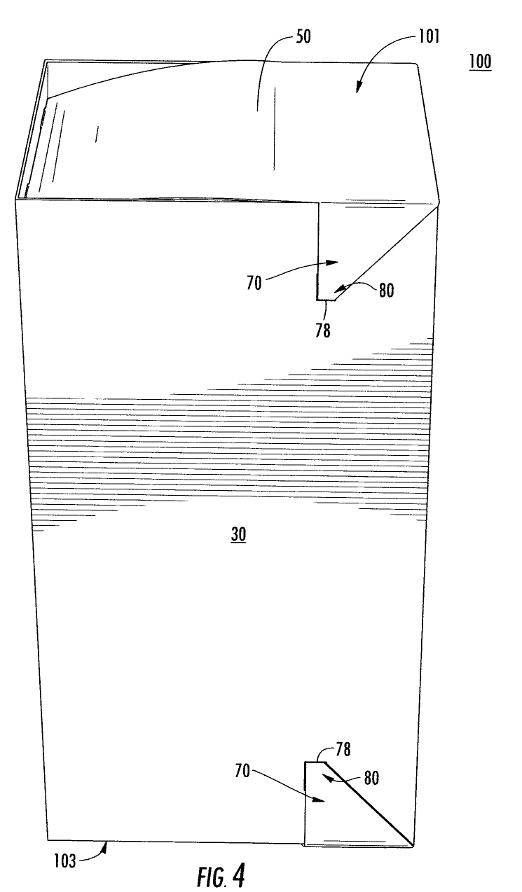

FIGS. 3 and 4 illustrated the carton 100 with both ends 101, 103 closed. The carton 100 has a generally parallelepipedal shape. When the ends 101, 103 of the carton 100 are closed by the end flaps 50, the first and second portions 72, 74 of the locking flap 70 are tucked in against an adjacent side panel 10 or 30 and held in place by engagement of the tip 80 of the locking flap 70 with a locking aperture 78. The end flaps 50 can, for example, substantially close the ends 101, 103 of the carton 100. Alternatively, the carton 100 may have opening or dispensing features in the end flaps 50 and/or the side panels 10, 20, 30, 40.

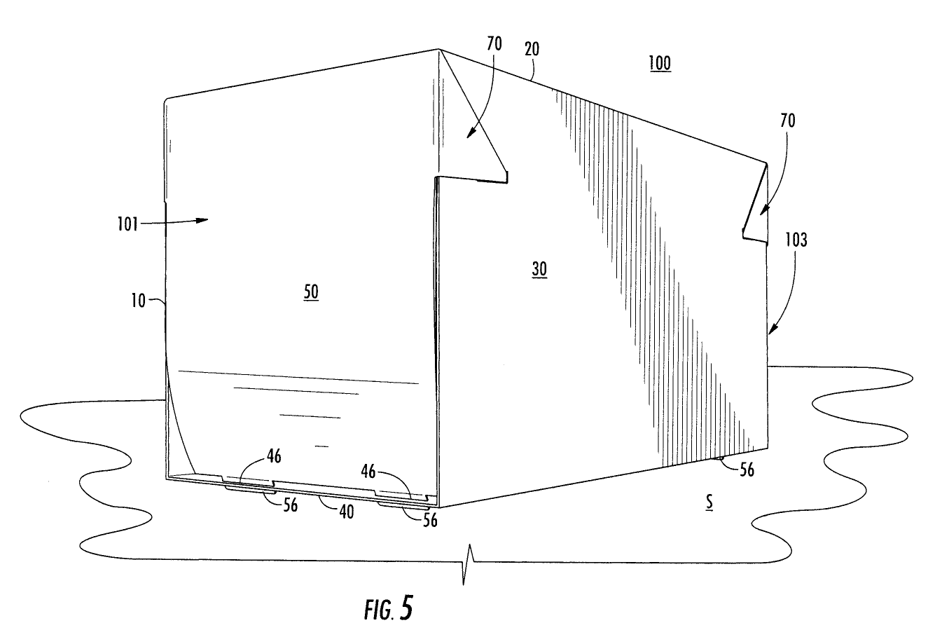

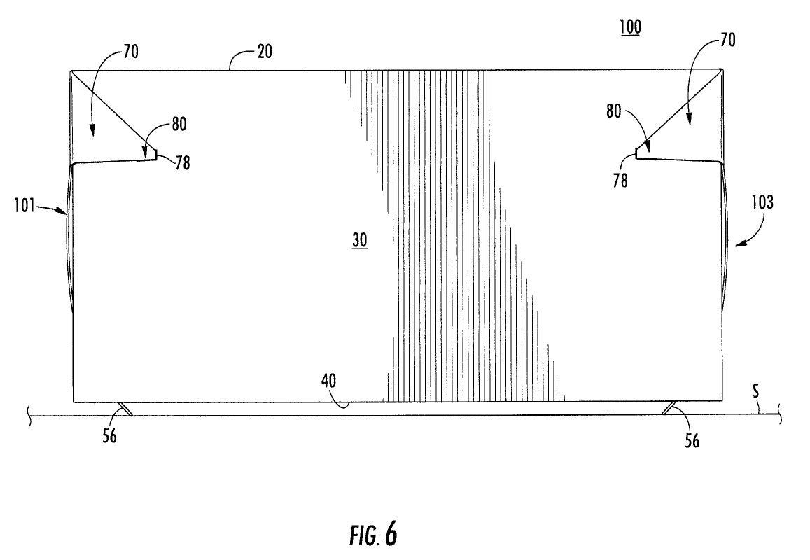

FIGS. 5 and 6 illustrate the erected and closed carton 100 in an orientation in which the carton is supported on the closure projections 56. In this arrangement the fourth side panel 40 is a bottom panel and is supported above a surface S by the closure projections that extend through the projection apertures 46.

In the illustrated embodiments, cutout sections struck from the blank 8, such as the projection apertures 46 and/or locking apertures 78, may alternatively be formed from knockout sections that are removed, for example, before or during erection of the blank. Slits or cuts may also be used to form the apertures 46.

The blank according to the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the carton to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines may include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

The above embodiments may be described as having one or more panels adhered together by glue during erection of the carton embodiments. The term “glue” is intended to encompass all manner of adhesives commonly used to secure carton panels in place.

The foregoing description illustrates and describes various embodiments of the present disclosure. As various changes could be made in the above construction, it is intended that all matter contained in the above description or shown in the accompanying drawings shall be interpreted as illustrative and not in a limiting sense. Furthermore, the present disclosure covers various modifications, combinations, alterations, etc., of the above-described embodiments. Additionally, the disclosure shows and describes only selected embodiments, but various other combinations, modifications, environments, changes, and/or modifications are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A carton for containing a plurality of articles, the carton comprising:
a plurality of panels that extend at least partially around an interior of the carton, the plurality of panels comprises at least a first side panel and a second side panel;
at least one end flap foldably connected to the first side panel, the end flap being for folding relative to the first side panel to at least partially close an end of the carton;
at least one locking flap foldably connected to the at least one end flap; and
a locking aperture in the second side panel for receiving at least a portion of the locking flap when the end flap at least partially forms the closed end of the carton.

2. The carton of claim 1 wherein the locking flap is also foldably connected to the second side panel.

3. The carton of claim 1 wherein the at least one locking flap is a first locking flap, the carton further comprising a second locking flap foldably connected to the at least one end flap.

4. The carton of claim 3 further comprising a third side panel foldably connected to the first side panel, the second locking flap also being foldably connected to the third side panel.

5. The carton of claim 4 wherein the locking aperture is a first locking aperture and the carton further comprises a second locking aperture in the third side panel for receiving at least a portion of the second locking flap when the end flap at least partially closes the end of the carton.

6. The carton of claim 1 wherein the locking flap comprises a first portion foldably connected to the end flap and a second portion foldably connected to the second side panel and the first portion.

7. The carton of claim 6 wherein the first portion is foldably connected to the second portion at an oblique fold line.

8. The carton of claim 6 wherein the first portion and the second portion are in an overlapping arrangement with respect to one another when the end flap at least partially closes the end of the carton.

9. The carton of claim 8 wherein the locking flap is downwardly folded relative to the end flap and at least partially inserted into the locking aperture.

10. The carton of claim 1 wherein the end is a first end, the at least one end flap is a first end flap, the at least one locking flap is a first locking flap, the carton further comprises a second end flap foldably connected to the first side panel for at least partially closing a second end of the carton and a second locking flap foldably connected to the second end flap.

11. The carton of claim 10 wherein the locking aperture is a first locking aperture, the carton further comprising a second locking aperture in the second side panel for receiving at least a portion of the second locking flap when the second end flap at least partially closes the second end of the carton.

12. The carton of claim 11 further comprising a third side panel foldably connected to the first side panel, a third locking flap foldably connected to the first end flap and the third side panel, and a fourth locking flap foldably connected to the second end flap and the third side panel.

13. The carton of claim 12 further comprising a third locking aperture in the third side panel for receiving at least a portion of the third locking flap when the first end flap at least partially closes the first end of the carton, and a fourth locking aperture in the third side panel for receiving at least a portion of the fourth locking flap when the second end flap at least partially closes the second end of the carton.

14. The carton of claim 1 wherein the at least one end flap comprises at least one closure projection at a marginal portion of the end flap.

15. The carton of claim 14 further comprising at least one projection aperture for receiving the at least one closure projection when the end flap at least partially closes the at end of the carton.

16. The carton of claim 15 wherein the carton further comprises a third side panel, the projection aperture is in the third side panel.

17. The carton of claim 16 wherein the end flap is a first end flap, the at least one closure projection is a first closure projection, the carton further comprises a second end flap foldably connected to the first side panel for at least partially closing a second end of the carton, the second end flap having at least one second closure projection at a marginal portion of the second end flap, and a second closure aperture in the third side panel for at least partially receiving the second closure projection.

18. A blank for forming a carton comprising:
a plurality of panels comprising at least a first side panel and a second side panel;
at least one end flap foldably connected to the first side panel for at least partially closing an end of the carton erected from the blank; and
closure features comprising a locking flap foldably connected to the at least one end flap and a locking aperture in the second side panel for receiving at least a portion of the locking flap when the end flap at least partially closes the end of the carton erected from the blank.

19. The blank of claim 18 wherein the locking flap comprises a first portion foldably connected to the end flap and a second portion foldably connected to the first side panel and the first portion.

20. The blank of claim 19 wherein the first portion is foldably connected to the second portion at an oblique fold line.

21. The blank of claim 18 wherein the end flap is a first end flap, the end is a first end, the at least one locking flap is a first locking flap, the blank further comprising a second end flap foldably connected to the first side panel for closing a second end of the carton erected from the blank and a second locking flap foldably connected to the second end flap.

22. The blank of claim 21 wherein the locking aperture is a first locking aperture, the blank further comprises a second locking aperture in the second side panel for receiving at least a portion of the second locking flap when the second end flap at least partially closes the second end of the carton erected from the blank.

23. The blank of claim 22 further comprising a third locking flap foldably connected to the first end flap, and a fourth locking flap foldably connected to the second end flap.

24. The blank of claim 23 further comprising a third side panel foldably connected to the first side panel, a third locking aperture in the third side panel for receiving at least a portion of the third locking flap when the first end flap at least partially closes the first end of the carton erected from the blank, and a fourth locking aperture in the third side panel for receiving at least a portion of the fourth locking flap when the second end flap at least partially closes the second end of the carton erected from the blank.

25. The blank of claim 18 wherein the at least one end flap comprises at least one closure projection at a marginal portion of the end flap and the blank further comprises at least one projection aperture for receiving the at least one closure projection when the end flap at least partially closes the end of the carton erected from the blank.

26. The blank of claim 25 further comprising a third side panel foldably connected to the second side panel, the projection aperture being in the third side panel.

27. A method of assembling a carton comprising:
providing a carton comprising a plurality of panels comprising at least a first side panel and a second side panel, at least one end flap foldably connected to the first side panel, at least one locking flap foldably connected to the at least one end flap, and a locking aperture in the second side panel;
folding the at least one end flap to at least partially close an end the carton; and
securing the at least one end flap in a position that at least partially closes the end of the carton, the securing comprising folding the at least one locking flap and inserting at least a portion of the locking flap into the locking aperture.

28. The method of claim 27 wherein the locking flap comprises a first portion foldably connected to the end panel and a second portion foldably connected to the first side panel and the first portion, and the folding the at least one end flap comprises at least partially overlapping the first portion and the second portion to form the locking flap.

29. The method of claim 27 wherein the end flap is a first end flap, the end is a first end, the at least one locking flap is a first locking flap, the carton further comprises a second end flap foldably connected to the first side panel, a second locking flap foldably connected to the second end flap, and the method further comprises folding the second end flap to at least partially close the second end and securing the second end flap in a position that at least partially closes the second end of the carton.

30. The method of claim 29 wherein the locking aperture is a first locking aperture, the carton further comprises a second locking aperture in the second side panel and the securing the second end flap comprises inserting at least a portion of the second locking flap into the second locking aperture.

31. The method of claim 30 wherein the carton further comprises a third side panel foldably connected to the first side panel, a third locking flap foldably connected to the first end flap, and a fourth locking flap foldably connected to the second end flap and the third side panel, a third locking aperture in the third side panel, and a fourth locking aperture in the third side panel, wherein the securing the first end flap comprises inserting at least a portion of the third locking flap in the third locking aperture and the securing the second end flap comprises inserting at least a portion of the fourth locking flap into the fourth locking aperture.

32. The method of claim 27 wherein the at least one end flap comprises at least one closure projection at a marginal portion of the end flap and the blank further comprises at least one projection aperture, the securing the end flap comprises inserting at least a portion of the at least one closure projection into the projection aperture when the end flap at least partially closes the end of the carton.

33. The method of claim 32 wherein the carton further comprises a third side panel foldably connected to the second side panel, the projection aperture being in the third side panel.

34. A carton for containing a plurality of articles, the carton comprising:
a plurality of panels that extend at least partially around an interior of the carton, the plurality of panels comprises a first side panel, a second side panel foldably connected to the first side panel, a third side panel foldably connected to the first side panel, and a fourth side panel foldably connected to at least one of the second and third side panels;
a first end flap foldably connected to the first side panel, the first end flap being for folding relative to the first side panel to at least partially close a first end of the carton;
a second end flap foldably connected to the first side panel, the second end flap being for folding relative to the first side panel to at least partially close a second end of the carton;
at least one first locking flap foldably connected to the first end flap, the at least one first locking flap comprising a first portion foldably connected to the first end flap and a second portion foldably connected to the first portion of the first locking flap and at least one of the second side panel and the third side panel;
at least one second locking flap foldably connected to the second end flap, the at least one second locking flap comprising a first portion foldably connected to the second end flap and a second portion foldably connected to the first portion of the second locking flap and at least one of the second side panel and third side panel;
a first locking aperture in the at least one of the second side panel and third side panel connected to the first locking flap, the first locking aperture being for receiving at least a portion of the first locking flap when the first end flap at least partially closes the first end of the carton;
a second locking aperture in the at least one of the second side panel and third side panel connected to the second locking flap, the second locking aperture being for receiving at least a portion of the second locking flap when the second end flap at least partially closes the second end of the carton.
